(19) United States
(12) Patent Application Publication
(10) Pub. No.: US 2007/0024562 A1
(43) Pub. Date: Feb. 1, 2007

(54) Liquid crystal display drivers and methods for driving the same

(76) Inventor: Sung-Pil Choi, Suwon-si (KR)

Correspondence Address: MYERS BIGEL SIBLEY & SAJOVEC, PO BOX 37428, RALEIGH, NC, 27627, US

(21) Appl. No.: 11/396,142

(22) Filed: Mar. 31, 2006

(30) Foreign Application Priority Data
Aug. 1, 2005 (KR) 10-2005-0070119

(51) Int. Cl. G09G 3/36

(52) U.S. Cl. 345/96

(57) ABSTRACT

Liquid crystal display drivers include a conversion control signal generator and an output driver. The conversion control signal generator is configured to generate a first conversion control signal and a second conversion control signal, offset from the first conversion control signal, based on an input clock signal and a polarity modulation signal for reversing polarity of pixel of the liquid crystal display. The output driver includes a plurality of amplifiers having input terminals whose polarities are reversed responsive to a selected one of the first conversion control signal or the second conversion control signal. The output driver is configured to selectively output corresponding output signals of the amplifiers as driving signals of the liquid crystal display based on the polarity modulation signal. Driving methods are also provided

### CROSS-REFERENCE TO RELATED APPLICATION

This application is related to and claims priority from Korean Patent Application No. 10-2005-0070119, filed on Aug. 1, 2005, in the Korean Intellectual Property Office, the disclosure of which is incorporated herein in its entirety by reference.

### BACKGROUND OF THE INVENTION

The present invention relates to display drivers and, more particularly, to a Liquid Crystal Display (LCD) driver and methods for driving the same.

Thin-Film Transistor-Liquid Crystal Displays (TFT-LCDs), which are widely used in notebooks, personal computers (PCs), monitors and the like are typically driven by source drivers and gate drivers. FIG. 1 is a circuit diagram illustrating the structure of a typical conventional TFT-LCD. The TFT-LCD illustrated in FIG. 1 includes a liquid crystal panel 1, a gate driver 2 and a source driver 3. Each pixel 11 of the liquid crystal panel 1 is modeled as a capacitor C1 and a switch T1.

The gate driver 2 typically turns on or off the gates of switches T1 through a plurality of gate lines G1, . . . , Gn. The source driver 3 typically outputs gray-scale voltages through corresponding source lines S1, . . . , Sm responsive to input data. That is, if the switches T1 connected to the gate lines G1, . . . , Gn are turned on by an output voltage of the gate driver 2, the gray-scale voltages output from the source driver 3 are applied to liquid crystal capacitors C1 connected to the turned-on switches T1, respectively.

One method of driving a TFT-LCD having the structure illustrated in FIG. 1 is a data inversion driving method that may prevent the liquid crystal from deteriorating due to a dc voltage. In the data inversion driving method, a LCD is AC-driven by alternately applying a positive (+) signal and a negative (−) signal to the same pixel.

FIG. 2 is a schematic diagram illustrating a dot inversion driving method that is an example of the data inversion driving method. As illustrated in FIG. 2, a first polarity voltage is applied to a pixel and a voltage of an opposite polarity is applied to pixels adjacent to the pixel in the horizontal and vertical directions. This alternating voltage polarity may cancel flickers generated in the adjacent pixels. The data inversion driving method may be used to limit or even prevent the liquid crystal in a LCD from being hardened and, as a result, may limit afterimages from appearing due to the hardening of the liquid crystal. In order to perform the data inversion driving method, a timing controller that provides timing signals to a driver typically generates a polarity modulation signal POL and reverses the polarities of driving voltages to be applied to pixels per each period in dot inversion.

Meanwhile, the source driver 3 of FIG. 1 may include a plurality of amplifiers (for example, operational amplifiers (OP-AMPs)), which are disposed at its output terminals to output gray-scale voltages. As each amplifier typically has a random DC offset, deviations may exist between voltages actually output from the respective amplifiers, even when a gray-scale voltage corresponding to the same input data is selected. In the source driver 3 including the plurality of the amplifiers, the deviations between output voltages existing between respective channels may generate a stripe pattern on a LCD screen. In order to reduce the deviations between the output voltages, a conventional method uses a conversion control signal obtained by dividing a polarity modulation signal to the amplifiers (the dividing may be by 2n, i.e, doubling the period for each sequential division) and, thus, reversing the polarities of the amplifiers.

FIG. 3A is a timing diagram illustrating a conversion control signal CHOP when inverting a polarity modulation signal POL in a conventional 1-horizontal pattern. Here, the 1-horizontal pattern means a pattern in which a polarity modulation signal POL is inverted per each clock pulse (or per each gate line where a next gate line is selected each clock pulse). A display pattern of a TFT-LCD can be classified into a 1-horizontal pattern, a 2-horizontal pattern, etc. according to the number of gate lines for which the polarity modulation signal POL that determines the polarity of the liquid crystal is inverted.

FIG. 3B is a timing diagram of the conversion control signal CHOP when inverting the polarity modulation signal POL in a conventional 2-horizontal pattern (i.e., inverting polarity every second clock pulse). Referring to FIG. 3B, in the 2-horizontal pattern, the periods of the polarity modulation signal POL and the conversion control signal CHOP are longer than in the 1-horizontal pattern illustrated in FIG. 3A. Thus, the length of a time in which offsets generated in the amplifiers are accumulated in the 2-horizontal pattern is greater than in the 1-horizontal pattern. Therefore, the 2-horizontal pattern has a higher probability of generating visible errors, such as a stripe pattern, than the 1-horizontal pattern.

### SUMMARY OF THE INVENTION

Embodiments of the present invention provide liquid crystal display drivers including a conversion control signal generator and an output driver. The conversion control signal generator is configured to generate a first conversion control signal and a second conversion control signal, offset from the first conversion control signal, based on an input clock signal and a polarity modulation signal for reversing polarity of pixel of the liquid crystal display. The output driver includes a plurality of amplifiers having input terminals whose polarities are reversed responsive to a selected one of the first conversion control signal or the second conversion control signal. The output driver is configured to selectively output corresponding output signals of the amplifiers as driving signals of the liquid crystal display based on the polarity modulation signal.

In other embodiments, the offset between the first conversion control signal and the second conversion control signal is based on the polarity modulation signal. The second conversion control signal may be generated using the first conversion control signal.

In further embodiments, the plurality of amplifiers include a plurality of pairs of amplifiers and the first conversion control signal and the second conversion control signal are alternately and sequentially input to the pairs of amplifiers. Ones of the pairs of the amplifiers may include different type voltage followers, each having a first terminal configured to receive a value for data to be displayed and a second terminal connected to an output terminal of the respective voltage follower.

In other embodiments, the conversion control signal generator is configured to generate the first conversion control signal by shifting the polarity modulation signal by a period of the clock signal and dividing the shifted polarity modulation signal, and to generate the second conversion control signal by shifting the first conversion control signal by a half period of the polarity modulation signal. The conversion control signal generator may include a first flip-flop having an input terminal coupled to the polarity modulation signal and a clock terminal coupled to the clock signal and a second flip-flop having an input terminal coupled to an output terminal of the first flip-flop and a clock terminal coupled to the clock signal. The conversion control signal generator may further include a third flip-flop having an input terminal and an inverted output terminal, the inverted output terminal being connected to the input terminal of the third flip-flop. The third flip-flop has a non-inverted output terminal that provides the first conversion control signal and having a clock terminal coupled to an output terminal of the second flip-flop An inverter of the conversion control signal generator has an input terminal coupled to the output terminal of the second flip-flop and a fourth flip-flop has an input terminal and an inverted output terminal, the inverted output terminal of the fourth flip-flop being connected to the input terminal of the fourth flip-flop. The fourth flip-flop has a non-inverted output terminal that provides the second conversion control signal and has a clock terminal coupled to an output terminal of the inverter.

In further embodiments, the conversion control signal generator includes a first flip-flop configured to receive and output the polarity modulation signal in response to the clock signal and a second flip-flop configured to receive and output the output signal from the first flip-flop in response to the clock signal. The conversion control signal generator further includes a third flip-flop, an inverted output terminal of which is connected to an input terminal of the third flip-flop. The third flip-flop is configured to output a signal to provide the first conversion control signal, in response to the output signal from the second flip-flop. The conversion control signal generator further includes an inverter configured to invert and output the output signal from the second flip-flop and a fourth flip-flop, an inverted output terminal of which is connected to an input terminal of the fourth flip-flop. The fourth flip-flop is configured to output a signal to provide the second conversion control signal, in response to the output signal of the inverter.

In yet other embodiments, methods of generating driving voltages in a driver of a liquid crystal display are provided, the driver including a plurality of amplifiers generating the driving voltages. A first conversion control signal and second conversion control signal phase shifted from the first conversion control signal by an interval based on a polarity modulation signal of the liquid crystal display are generated. The driving voltages are generated by controlling an offset of ones of the plurality of amplifiers by applying a selected one of the first conversion control signal or the second conversion control thereto and by controlling a polarity of the driving voltages based on the polarity modulation signal.

In some embodiments, the first conversion control signal and the second conversion control signal select a positive or a negative offset level of the plurality of amplifiers. A timing of the first conversion control signal, the second conversion control signal and the polarity modulation signal are selected to prevent a width of a switching voltage between levels of the driving signals from including an increase from offsets applied thereto of a cumulative amount of the positive offset level and the negative offset level.

In further embodiments, methods of generating driving voltages in a driver of a liquid crystal display are provided, the driver including a plurality of amplifiers generating the driving voltages. A first conversion control signal is generated based on an input clock signal and a polarity modulation signal. A second conversion control signal is generated based on the input clock signal and the polarity modulation signal. The first and second conversion control signal have a phase difference therebetween. The first conversion control signal or the second conversion control signal are selectively applied to the amplifiers to reverse polarities of input terminals of the amplifiers. Output signals of the amplifiers are selectively switched based on the polarity modulation signal and the resultant signals are output as the driving voltages.

In yet further embodiments, generating the second conversion control signal includes generating the second conversion control signal based on the first conversion control signal. The first conversion control signal and the second conversion control signal may be alternately and sequentially input to a pair of the amplifiers.

In other embodiments, generating the first conversion control signal includes shifting the polarity modulation signal by a period of the clock signal and dividing the shifted polarity modulation signal. Generating the second conversion control signal includes shifting the first conversion control signal by half the period of the polarity modulation signal. When the polarity modulation signal is at a first level, a first-polarity offset may be generated in the driving signal when the first conversion control signal is at the first level, and a second-polarity offset may be generated in the driving signal when the first conversion control signal is at a second level to reduce offsets of the amplifiers.

### BRIEF DESCRIPTION OF THE DRAWINGS

The present invention will be described with reference to exemplary embodiments thereof illustrated in the attached drawings, in which:

FIG. 1 is a circuit diagram illustrating the structure of a conventional Thin Film Transistor-Liquid Crystal Display (TFT-LCD);

FIG. 2 is a schematic diagram illustrating a dot inversion method for the conventional TFT-LCD of FIG. 1;

FIG. 3A is a timing diagram illustrating a conversion control signal when inverting a polarity modulation signal in a conventional 1-horizontal pattern;

FIG. 3B is a timing diagram illustrating a conversion control signal when inverting a polarity modulation signal in a conventional 2-horizontal pattern;

FIG. 4 is a block diagram illustrating a LCD driver according to some embodiments of the present invention;

FIG. 5 is a timing diagram illustrating a clock signal and a polarity modulation signal, a conventional conversion control signal, and first and second conversion control signals for the LCD driver of FIG. 4 according to some embodiments of the present invention;

FIG. 6 is a circuit diagram illustrating amplifiers that, respectively, output odd-numbered driving signals and even-numbered driving signals suitable for use as the output driver in the LCD driver of FIG. 4 according to some embodiments of the present invention;

FIG. 7 is a circuit diagram illustrating the conversion control signal generator of FIG. 4 according to some embodiments of the present invention;

FIG. 8 is a schematic diagram illustrating first and second conversion control signals supplied to the amplifiers of the output driver of FIG. 4 and corresponding driving signals according to some embodiments of the present invention;

FIGS. 9A-9E are timing diagrams illustrating signals that are input to or output from a conventional output driver; and

FIGS. 10A-10F are timing diagrams illustrating signals that are input to or output from an output driver according to some embodiments of the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

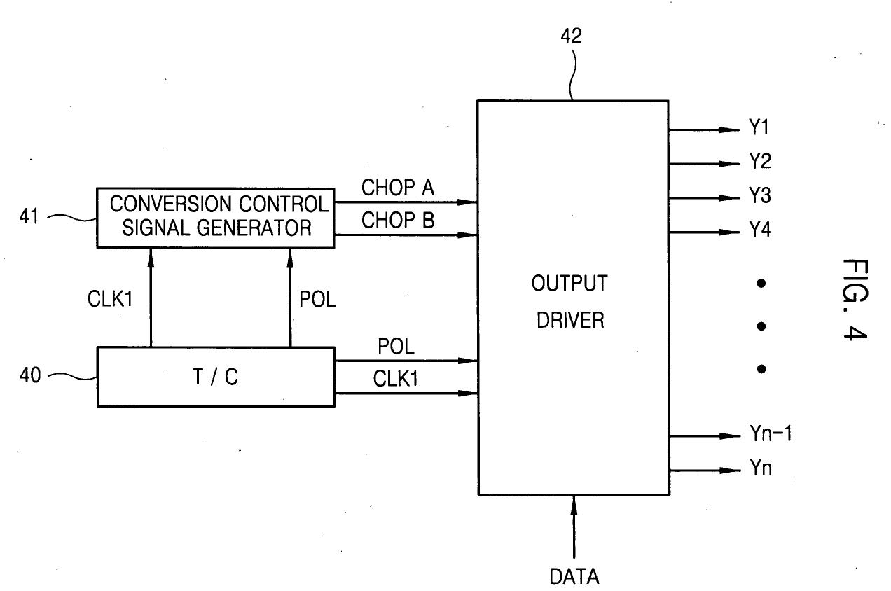

FIG. 4 is a block diagram of a liquid crystal display (LCD) driver according to some embodiments of the present invention. Referring to FIG. 4, the LCD driver includes a timing controller (T/C) 40, a conversion control signal generator 41, and an output driver 42.

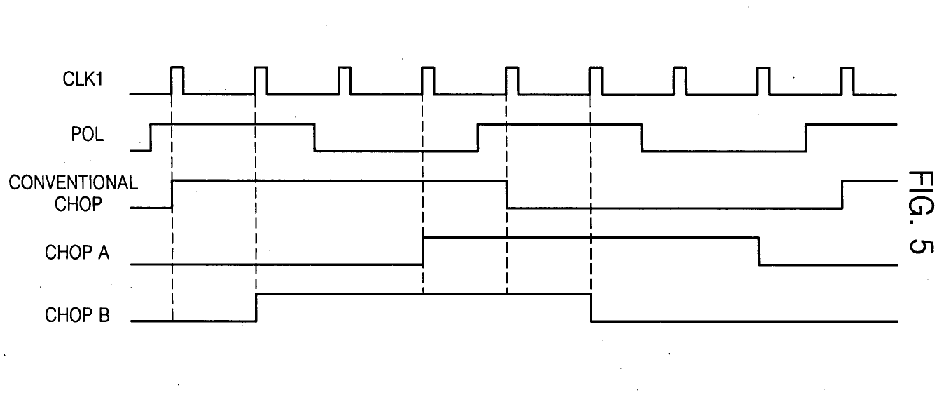

The T/C 40 generates a clock signal CLK1 for controlling the output driver 42 and generates a polarity modulation signal POL by dividing the clock signal CLK1 (see FIG. 5). The conversion control signal generator 41 generates a first conversion control signal CHOPB and a second conversion control signal CHOPA by dividing the polarity modulation signal POL in synchronization with the clock signal CLK1 (see FIG. 5). A time difference between the first conversion control signal CHOPB and the second conversion control signal CHOPA corresponds to two cycles of the clock signal CLK1, which may prevent adjacent signals among driving signals Y1, . . . , Yn output from the output driver 42 from being maintained at the same level for more than a predetermined period of time.

FIG. 5 is a timing diagram illustrating the clock signal CLK1, the polarity modulation signal POL, the conventional conversion control signal CHOP, and the first and second conversion control signals CHOPB and CHOPA according to some embodiments of the present invention. The output driver 42 of FIG. 4 includes amplifiers respectively generating the driving signals Y1, . . . , Yn, and outputs the driving signals Y1, . . . , Yn according to data to be displayed, using the first conversion control signal CHOPB, the second conversion control signal CHOPA, the clock signal CLK1, and the polarity modulation signal POL.

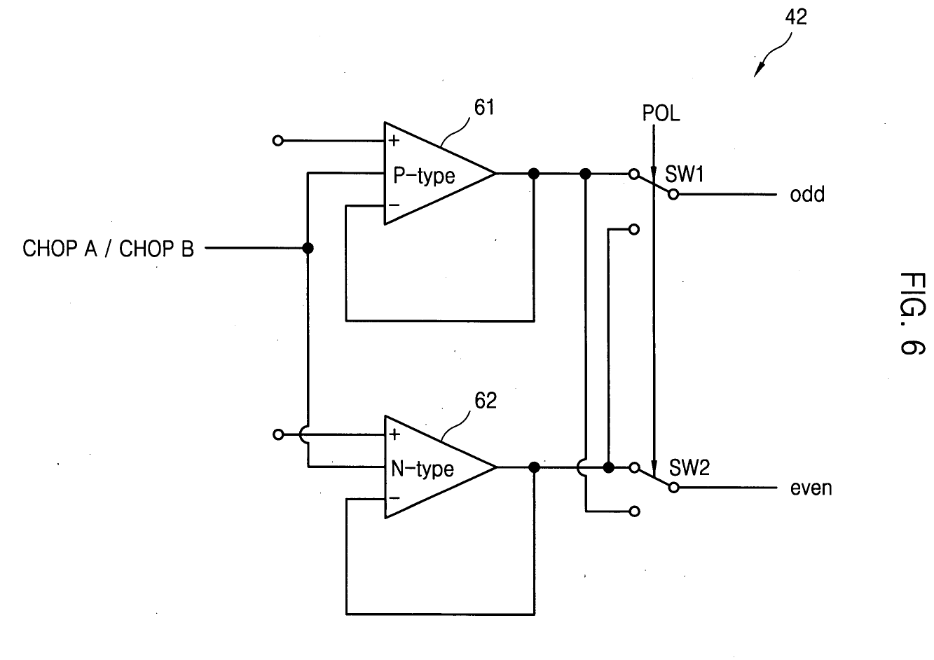

FIG. 6 is a circuit diagram illustrating first and second amplifiers 61 and 62, that may be included in the output driver 42 of FIG. 4, according to some embodiments of the present invention. The first and second amplifiers 61 and 62 respectively output an odd-numbered driving signal and an even-numbered driving signal.

The first amplifier 61 may be a P-type voltage follower whose positive (+) terminal receives a first gray-scale voltage into which first data to be displayed is converted. The second amplifier 62 may be an N-type voltage follower whose positive (+) terminal receives a second gray-scale voltage into which second data to be displayed is converted. The first and second gray-scale voltages may be generated by decoders that select and output values corresponding to the first and second data from among a plurality of gray-scale voltages.

The first conversion control signal CHOPB or a second conversion control signal CHOPA is used to switch the polarities of the first and second amplifiers 61 and 62 to remove an offset. A process of switching the polarities of the first and second amplifiers 61 and 62 according to some embodiments of the present invention will now be described.

If the first conversion control signal CHOPB or the second conversion control signal CHOPA is supplied to the first amplifier 61 when the first gray-scale voltage is applied to a positive (+) terminal of the first amplifier 61 and a negative (−) terminal of the first amplifier 61 is connected to its output terminal, the positive (+) and the negative (−) terminals are switched so that the first gray-scale voltage is input to the negative (−) terminal and the positive (+) terminal is connected to the output terminal. In this state, if the first conversion control signal CHOPB or the second conversion control signal CHOPA is supplied to the first amplifier 61 again, the positive (+) and the negative (−) terminals of the first amplifier 61 are switched again to the configuration shown in FIG. 6.

The first and second amplifiers 61 and 62, respectively, are coupled to a first switch SW1 and a second switch SW2, which are turned on or off in response to a polarity modulation signal POL. That is, the first and second switches SW1 and SW2 connect an output of the first amplifier 61 to an odd-numbered source line and an output of the second amplifier 62 to an even-numbered source line, or vice versa.

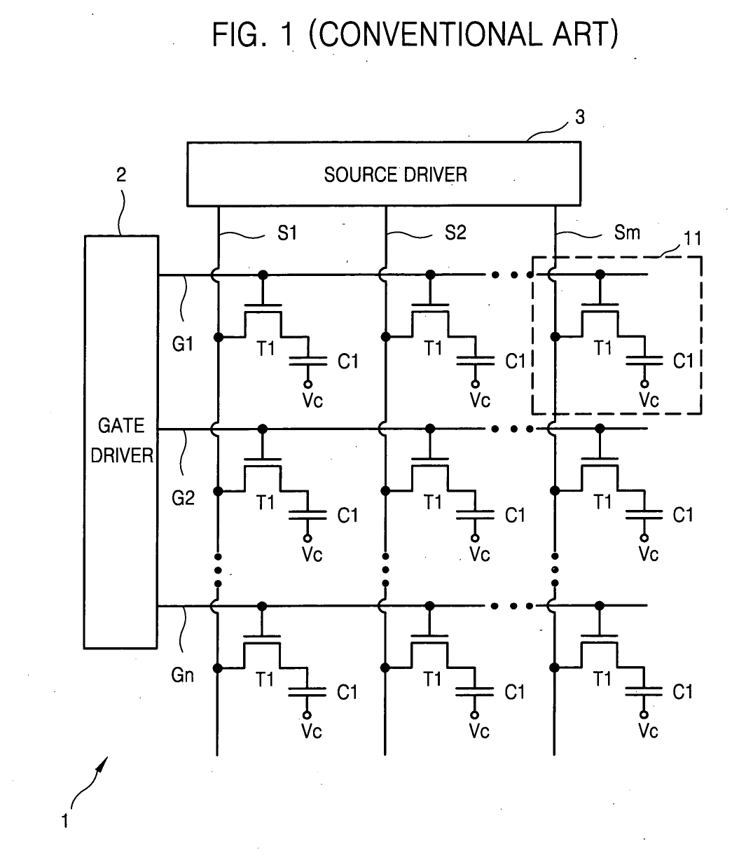

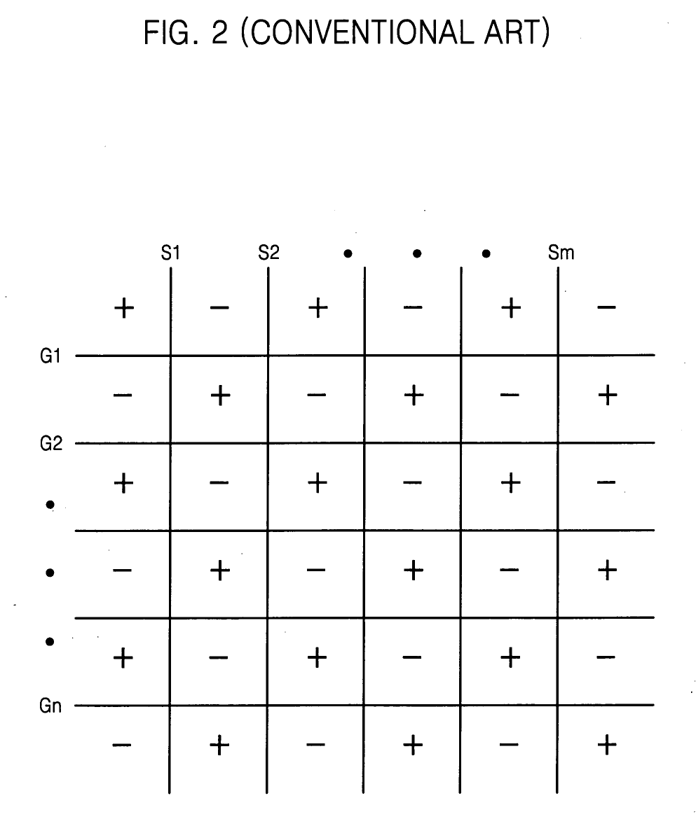

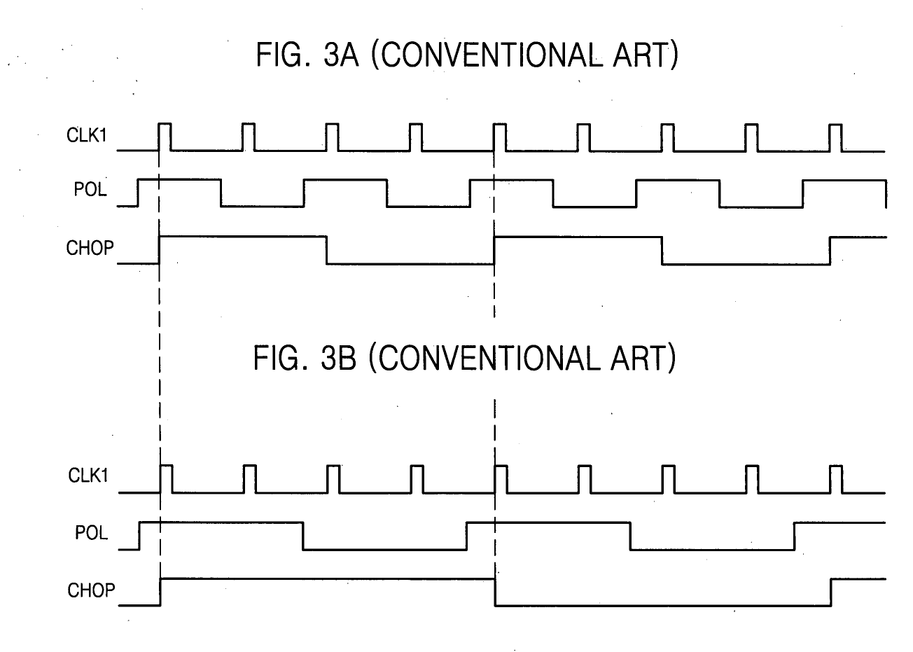

For example, in the liquid crystal panel 1 of FIG. 1, when switches T1 connected to the first gate line G1 in a liquid crystal panel 1 are turned on, an output of the first amplifier 61 is output to a first source line Y1 (S1 in FIG. 1) and an output of the second amplifier 62 is output to a second source line Y2 (S2 in FIG. 1). However, when switches T1 connected to a second gate line G2 in the liquid crystal panel 1 are turned on, the output of the first amplifier 61 may be output to the second source line S2 (or Y2) and the output of the second amplifier 62 may be output to the first source line S1 (or Y1).

As described above, the polarity modulation signal POL may be inverted per each gate line and per every frame. Accordingly, the polarities of voltages applied to neighboring pixels in the liquid crystal panel 1 may be different from each other and the voltage polarity of each pixel is reversed in units of frames.

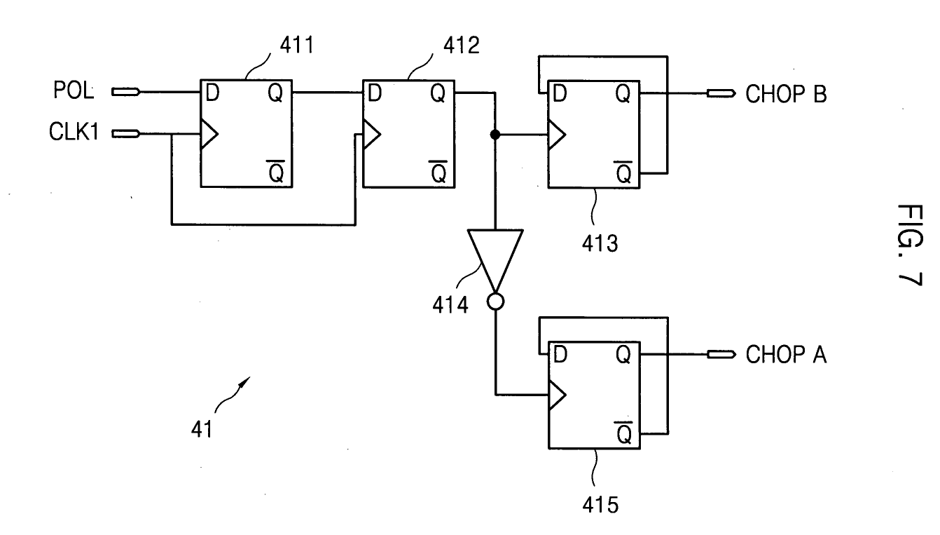

FIG. 7 is a detailed circuit diagram of the conversion control signal generator 41 illustrated in FIG. 4 according to some embodiments of the present invention. The conversion control signal generator 41 includes a plurality of D flip-flops 411, 412, 413 and 415 and an inverter 414. A polarity modulation signal POL is input to an input terminal of the first D flip-flop 411 and a clock signal CLK1 is input to a clock terminal of the first D flip-flop 411. The output of a non-inverted output terminal Q of the first D flip-flop 411 is supplied to an input terminal of the second D flip-flop 412 and the clock signal CLK1 is supplied to a clock terminal of the second D flip-flop 412.

The output of a non-inverted output terminal Q of the second D flip-flop 412 is supplied to a clock terminal of the third D flip-flop 413, and the output of a non-inverted output terminal Q of the third flip-flop 413 is supplied as a first conversion control signal CHOPB. The output of an inverted output terminal /Q of the third D flip-flop 413 is supplied to an input terminal of the third D flip-flop 413.

The output of the non-inverted output terminal Q of the second D flip-flop 412 is also inverted by the inverter 414 and supplied to a clock terminal of the fourth D flip-flop 415. The output of an inverted output terminal /Q of the fourth D flip-flop 415 is supplied to an input terminal of the fourth D flip-flop 415 and the output of a non-inverted output terminal Q of the fourth D flip-flop 415 is supplied as a second conversion control signal CHOPA.

Accordingly, referring to FIG. 5, the first conversion control signal CHOPB is generated by shifting the polarity modulation signal POL by a horizontal period of the clock signal CLK1 and then dividing the shifted polarity modulation signal POL in synchronization with the clock signal CLK1. The second conversion control signal CHOPA is generated by shifting the first conversion control signal CHOPB by the half period of the polarity modulation signal POL and dividing.

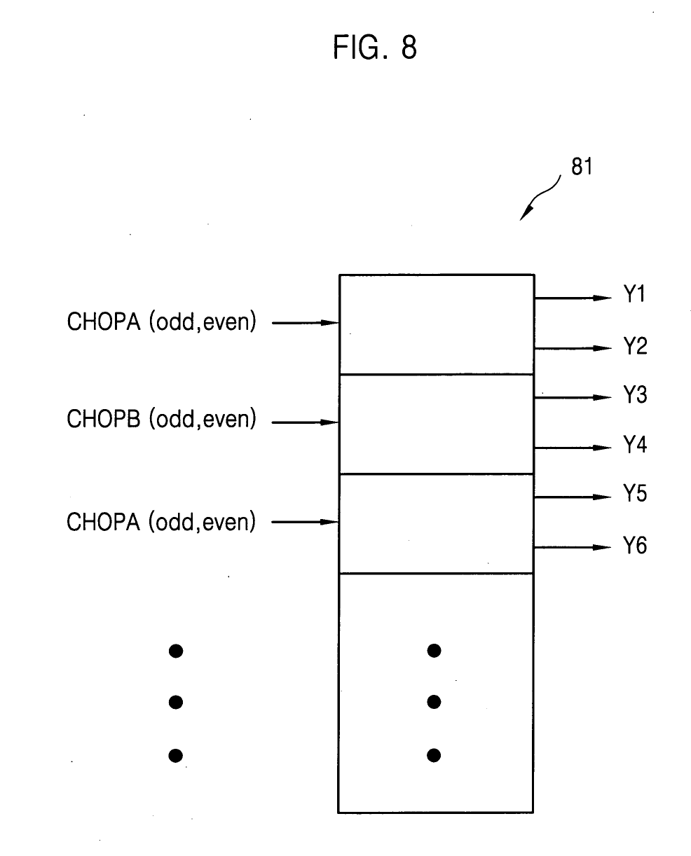

FIG. 8 is a schematic view illustrating the first and second conversion control signals CHOPB and CHOPA supplied to amplifiers 81 of the output driver 42 illustrated in FIG. 4, and corresponding driving signals. Referring to FIG. 8, the first conversion control signal CHOPB and the second conversion control signal CHOPA are alternately applied to the respective amplifiers 81.

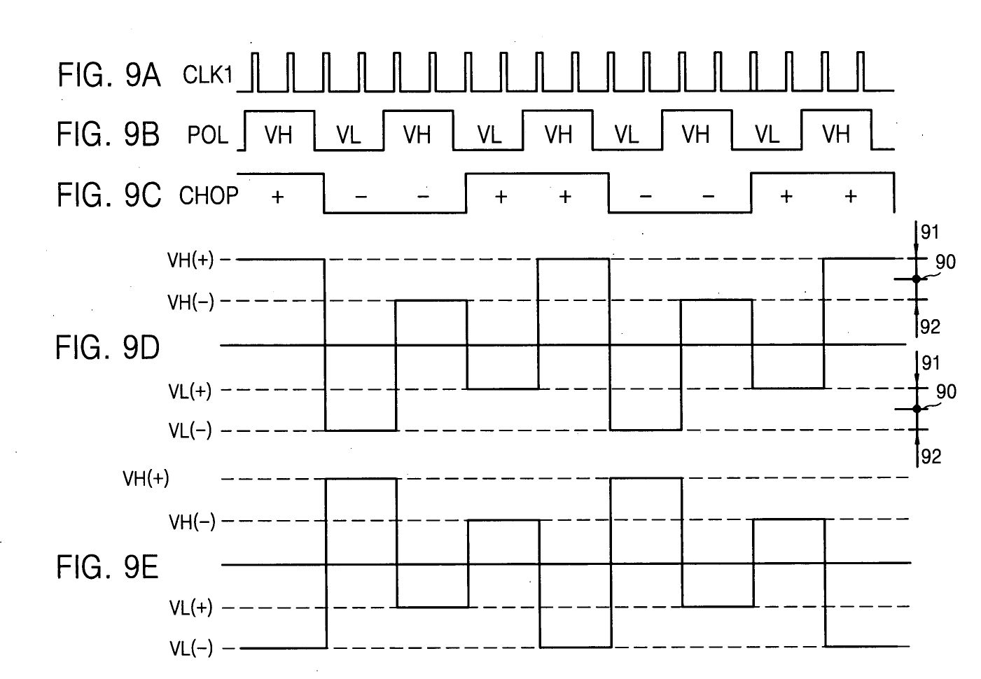

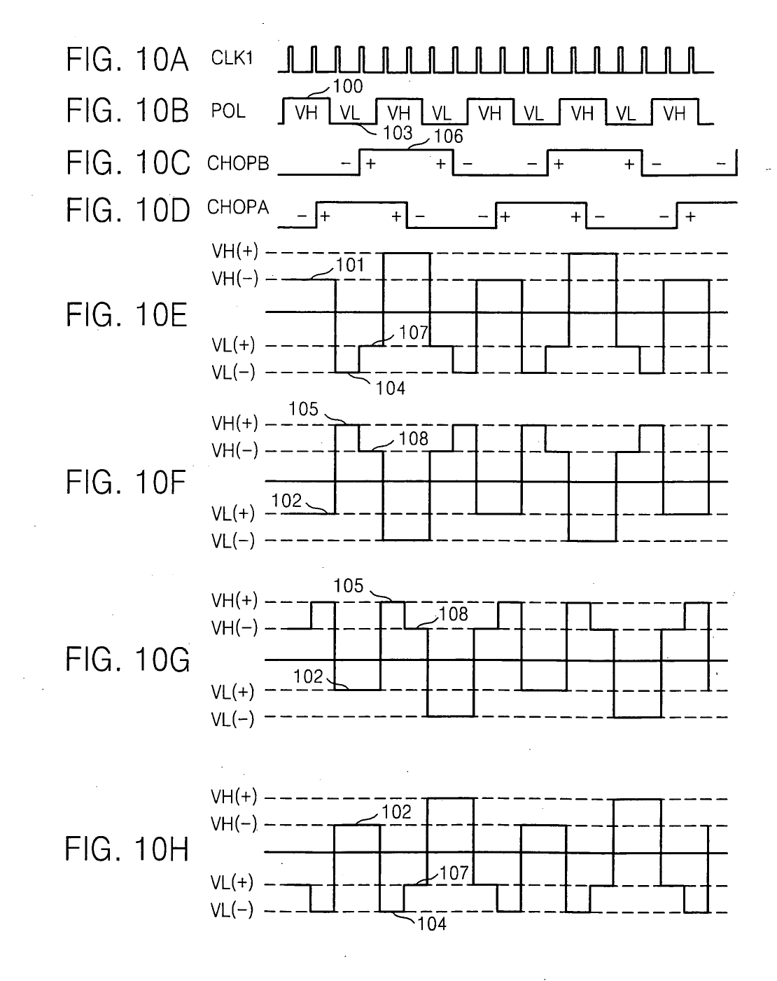

FIGS. 9A-9E are timing diagrams illustrating signals that are input to and output from a conventional output driver. FIGS. 10A-10F are timing diagrams illustrating signals that are input to and output from the output driver 42, shown in FIG. 4, according to some embodiments of the present invention.

FIG. 9A illustrates a clock signal CLK1. FIG. 9B illustrates a polarity modulation signal POL generated by dividing the clock signal CLK1. FIG. 9C illustrates a conventional conversion control signal CHOP. FIGS. 9D and 9E illustrate an odd-numbered driving signal and an even-numbered driving signal, respectively. Reference numerals 91 and 92 respectively represent the offset values of a driving signal converted into levels VH(+) and VH(−) from an original reference value 90. In other words, reference numerals 91 and 92 respectively represent offset values causing a desired level value 90 of a driving signal to be changed to levels VH(+) and VH(−).

As illustrated in FIGS. 9A-9E, use of the conversion control signal CHOP generated by dividing the polarity modulation signal POL doubles the length of the conversion control signal (CHOP) remaining at the same level in a 1-horizontal pattern. In this case, an offset may be removed by alternately generating a positive offset and a negative offset in a driving signal according to the conversion control signal CHOP, thus achieving zero-sum. However, visible errors, such as stripes, may occur because offset periods having the same level are increased. Further, as the level of the driving signal is changed from VH(+) to VL(−) when the polarity modulation signal POL is changed from “high” to “low”, the width of a switching voltage causing the visible errors doubles the width of the offset.

Accordingly, in some embodiments of the present invention, it is possible to limit or even prevent occurrence of offset periods having the same level from being increased by increasing the number of times that a driving signal alternately has a positive (+) level and a negative (−) level. Also, it may be possible to prevent visual errors from occurring by reducing the width of a switching voltage by switching an output level of the driving signal only between VH(+) and VL(+) or between VH(−) and VL(−) according to the change of the polarity modulation signal POL.

FIG. 10A illustrates a clock signal CLK1. FIG. 10B illustrates a polarity modulation signal POL obtained by dividing the clock signal CLK1. FIGS. 10C and 10D, respectively, illustrate a first conversion control signal CHOPB and a second conversion control signal CHOPA according to some embodiments of the present invention. FIGS. 10E and 10F, respectively, illustrate signals output from the amplifiers 61 and 62, which are generated in synchronization with the clock signal CLK1 when the first conversion control signal CHOPB is received. FIGS. 10G and 10H, respectively, illustrate signals output from the amplifiers 61 and 62, which are generated in synchronization with the clock signal CLK1 when the second conversion control signal CHOPA is received.

The polarity modulation signal POL and either the first conversion control signal CHOPB or the second conversion control signal CHOPA are applied to odd-numbered amplifier 61 and even-numbered amplifier 62. Referring to FIGS. 10A-10H, the first conversion control signal CHOPB and the second conversion control signal CHOPA are alternately changed between a positive (+) level and a negative (−) level in a period during which the polarity modulation signal POL maintains at the same level (i.e., CHOPA and CHOPB change level in a time period when the polarity modulation signal POL is unchanged).

In the illustrated embodiments, when the polarity modulation signal POL is “high” (100), an output signal of the odd-numbered amplifier 61 has a level VH(−) (101 of FIG. 10E) and an output signal of the even-numbered amplifier 62 has a level VL(+) (102 of FIG. 10F).

When the polarity modulation signal POL goes “low” (103), an output signal of the odd-numbered amplifier 61 falls to a level VL(−) (104 of FIG. 10E) and an output signal of the even-numbered amplifier 62 rises to a level VH(+) (105 of FIG. 10F). At this time, if the first conversion control signal CHOPB goes “high” (106 of FIG. 10C), an output signal of the odd-numbered amplifier 61 rises to a level VL(+) (107 of FIG. 10E) due to a positive (+) offset of the level VL(−) (104 of FIG. 10E), and an output signal of the even-numbered amplifier 62 falls to a level VH(−) (108 of FIG. 10F) due to a negative (−) offset of the level VH(+) (105 of FIG. 10F). Referring to FIGS. 10E and 10F, a positive (+) offset and a negative (−) offset are alternately and periodically generated, which may thereby remove an offset.

Also, referring to FIGS. 10G and 10H, by applying a different conversion control signal CHOPB or CHOPA to adjacent amplifiers, it is possible to limit or even prevent offset periods having the same level from being increased in adjacent driving signals. In other words, compared to FIGS. 9D and 9E, a transition with a doubled offset in a single transition does not appear in FIGS. 10E to 10H.

As described above, according some embodiments of the present invention, it is possible to limit or even remove an offset of a driving signal by increasing a number of times that the offset of the driving signal alternatively has a positive (+) level and a negative (−) level. Further, it is possible to limit or even remove the source of visual errors, such as stripes, by reducing the width of a switching voltage between the levels of a driving signal, compared to the conventional technique.

Some embodiments of the present invention provide a liquid crystal display (LCD) driver for removing offsets accumulated in amplifiers by shifting a first conventional conversion control signal by a horizontal period, i.e., by a pulse period of a clock signal, adding a second conversion control signal, and additionally shifting the second conversion control signal by the half period of a polarity modulation signal. Driving methods thereof are also provided by some embodiments of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A liquid crystal display driver circuit, comprising:
a conversion control signal generator configured to generate a first conversion control signal and a second conversion control signal, offset from the first conversion control signal, based on an input clock signal and a polarity modulation signal for reversing polarity of pixel of the liquid crystal display; and
an output driver including a plurality of amplifiers having input terminals whose polarities are reversed responsive to a selected one of the first conversion control signal or the second conversion control signal, the output driver being configured to selectively output corresponding output signals of the amplifiers as driving signals of the liquid crystal display based on the polarity modulation signal.

2. The driver of claim 1, wherein the offset between the first conversion control signal and the second conversion control signal is based on the polarity modulation signal.

3. The driver of claim 1, wherein the second conversion control signal is generated using the first conversion control signal.

4. The driver of claim 1, wherein the plurality of amplifiers comprise a plurality of pairs of amplifiers and wherein the first conversion control signal and the second conversion control signal are alternately and sequentially input to the pairs of amplifiers.

5. The driver of claim 4, wherein ones of the pairs of the amplifiers comprise different type voltage followers, each having a first terminal configured to receive a value for data to be displayed and a second terminal connected to an output terminal of the respective voltage follower.

6. The driver of claim 1, wherein the conversion control signal generator is configured to generate the first conversion control signal by shifting the polarity modulation signal by a period of the clock signal and dividing the shifted polarity modulation signal, and to generate the second conversion control signal by shifting the first conversion control signal by a half period of the polarity modulation signal.

7. The driver of claim 6, wherein the conversion control signal generator comprises:
a first flip-flop having an input terminal receives the polarity modulation signal and a clock terminal receives the clock signal;
a second flip-flop having an input terminal coupled to an output terminal of the first flip-flop and a clock terminal receives the clock signal;
a third flip-flop having an input terminal and an inverted output terminal, the inverted output terminal being connected to the input terminal of the third flip-flop, the third flip-flop having a non-inverted output terminal that provides the first conversion control signal and having a clock terminal coupled to an output terminal of the second flip-flop;
an inverter having an input terminal coupled to the output terminal of the second flip-flop; and
a fourth flip-flop having an input terminal and an inverted output terminal, the inverted output terminal of the fourth flip-flop being connected to the input terminal of the fourth flip-flop, the fourth flip-flop having a non-inverted output terminal that provides the second conversion control signal and having a clock terminal coupled to an output terminal of the inverter.

8. The driver of claim 6, wherein the conversion control signal generator comprises:
a first flip-flop configured to receive and output the polarity modulation signal in response to the clock signal;
a second flip-flop configured to receive and output the output signal from the first flip-flop in response to the clock signal;
a third flip-flop, an inverted output terminal of which is connected to an input terminal of the third flip-flop, the third flip-flop being configured to output a signal to provide the first conversion control signal, in response to the output signal from the second flip-flop;
an inverter configured to invert and output the output signal from the second flip-flop; and
a fourth flip-flop, an inverted output terminal of which is connected to an input terminal of the fourth flip-flop, the fourth flip-flop being configured to output a signal to provide the second conversion control signal, in response to the output signal of the inverter.

9. A method of generating driving voltages in a driver of a liquid crystal display, the driver including a plurality of amplifiers generating the driving voltages, the method comprising:
generating a first conversion control signal and second conversion control signal phase shifted from the first conversion control signal by an interval based on a polarity modulation signal of the liquid crystal display; and
generating the driving voltages by controlling an offset of ones of the plurality of amplifiers by applying a selected one of the first conversion control signal or the second conversion control thereto and by controlling a polarity of the driving voltages based on the polarity modulation signal.

10. The method of claim 9, wherein the first conversion control signal and the second conversion control signal select a positive or a negative offset level of the plurality of amplifiers and wherein a timing of the first conversion control signal, the second conversion control signal and the polarity modulation signal are selected to prevent a width of a switching voltage between levels of the driving signals from including an increase from offsets applied thereto of a cumulative amount of the positive offset level and the negative offset level.

11. A method of generating driving voltages in a driver of a liquid crystal display, the driver including a plurality of amplifiers generating the driving voltages, the method comprising:
generating a first conversion control signal based on an input clock signal and a polarity modulation signal;
generating a second conversion control signal based on the input clock signal and the polarity modulation signal, the first and second conversion control signal having a phase difference therebetween;
selectively applying the first conversion control signal or the second conversion control signal to the amplifiers to reverse polarities of input terminals of the amplifiers; and
selectively switching output signals of the amplifiers based on the polarity modulation signal and outputting the resultant signals as the driving voltages.

12. The method of claim 11, wherein generating a second conversion control signal comprises generating the second conversion control signal based on the first conversion control signal.

13. The method of claim 12, wherein the first conversion control signal and the second conversion control signal are alternately and sequentially input to a pair of the amplifiers.

14. The method of claim 11, wherein generating the first conversion control signal comprises:
shifting the polarity modulation signal by a period of the clock signal; and
dividing the shifted polarity modulation signal, wherein generating the second conversion control signal comprises shifting the first conversion control signal by half the period of the polarity modulation signal.

15. The method of claim 14, wherein, when the polarity modulation signal is at a first level, a first-polarity offset is generated in the driving signal when the first conversion control signal is at the first level, and a second-polarity offset is generated in the driving signal when the first conversion control signal is at a second level to reduce offsets of the amplifiers.
